(19) United States
(12) Patent Application Publication
(10) Pub. No.: US 2008/0245240 A1
(43) Pub. Date: Oct. 9, 2008

(54) Heat isolation structure for baking trays

(76) Inventor: Samson Tsen, Taipei City (TW)

Correspondence Address: Joe McKinney Muncy, PO Box 1364, Fairfax, VA, 22038-1364, US

(21) Appl. No.: 11/730,730

(22) Filed: Apr. 3, 2007

(51) Int. Cl. A47J 37/12

(52) U.S. Cl. 99/353

(57) ABSTRACT

A heat isolation structure for baking trays mainly includes a base which has an open surface, a heat transfer element located on the open surface to transfer heat energy that has a first surface in contact with food and a second surface on another side opposing the first surface, and a housing space formed between the base and the second surface. The housing space has a heat isolation member to prevent the heat energy from transferring to the base. Thus high temperature heat energy of the heat transfer element is prevented from transferring to the base. Thereby the trays with the base made from plastics that tend to be damaged by burning or melting due to overheat can be maintained intact after adopting the heat isolation member of the invention.

### FIELD OF THE INVENTION

The present invention relates to a baking tray and particularly to a heat isolation structure for a baking tray that has a heat isolation member to isolate heat from damaging the base of the baking tray by burning or melting.

### BACKGROUND OF THE INVENTION

Advance of technology and the progress of society have increased the awareness and demand of people on living quality in almost every aspect of life, including foods, clothes, houses and transportation. For instance, electric oven tray or microwave baking tray is now widely used due to its simple operation. Consumers can easily bake pancakes or roast meat and the like at home in a hygienic fashion at a lower cost. It is convenient and can save a lot of time. Thus it becomes quite popular.

U.S. Pat. No. 6,608,292B1 discloses a microwave grilling appliance to convert microwave energy to heat energy for baking or heating foods. In mainly includes a first grill element containing a first microwave absorbent portion and a first heat conducting element. The first heat conducting element has a first surface in contact with the microwave absorbent portion and a second surface in contact with the baking food or other baking stuffs. There is a microwave transparent base to support the first grill element. The base and the first heat conducting element seal the microwave absorbent portion. There is also a second grill element containing a second microwave absorbent portion and a second heat conducting element. The second heat conducting element has a third surface in contact with the second microwave absorbent portion and a fourth surface in contact with the baking food or other baking stuffs. A microwave transparent upper lid is provided to support the grill element and join the second heat conducting element to seal the second microwave absorbent portion. A spindle is provided to keep the fourth surface to move substantially in parallel with the second surface, and also allow the upper lid to rotate beneath a first detent position between 90 and 180 degrees.

However the first and second grill elements have extended lips on the peripheral edge in contact with the base and upper lid without any heat isolation structure interposed between them. When in use for a period of time or overheat occurs, high temperature heat energy is directly transferred to the base or upper lid. As the base or upper lid of the conventional baking tray is made from plastics, it is prone to be damaged by burning or melting. And toxic material could be generated to threaten the health of people. There are still rooms for improvement.

### SUMMARY OF THE INVENTION

The primary object of the present invention is to provide a heat isolation structure for baking trays to prevent high temperature heat energy of a heat transfer element from transferred to a base, especially for the baking trays that have the base made from plastics to avoid the plastic base from being damaged by burning or melting.

To achieve the foregoing object an embodiment of the invention includes a base which has a housing space and an open surface located therein that has a heat transfer element to transfer heat energy. The heat transfer element has a first surface in contact with food and a second surface on another side opposing the first surface. The housing space further has a heat isolation member located between the base and the second surface to isolate the heat energy from transferring to the base.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of an embodiment of the invention.

FIG. 2 is an exploded view of an embodiment of the invention.

FIG. 3 is a fragmentary sectional view of an embodiment of the invention.

### DETAILED DESCRIPTION OF THE PREFERRED EMBODIMENT

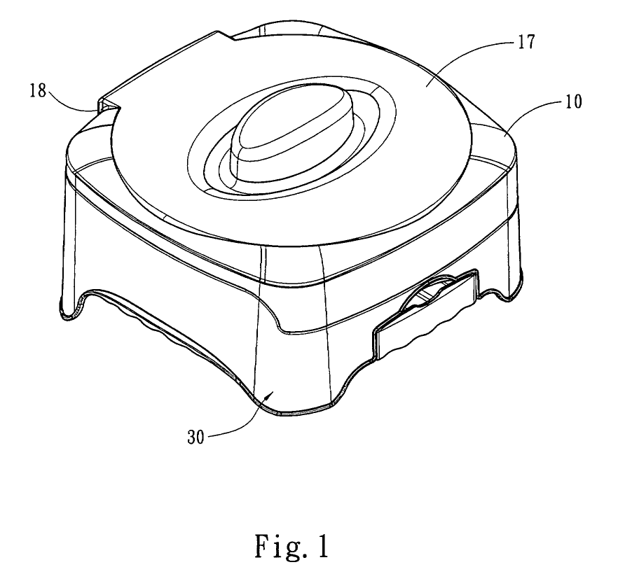

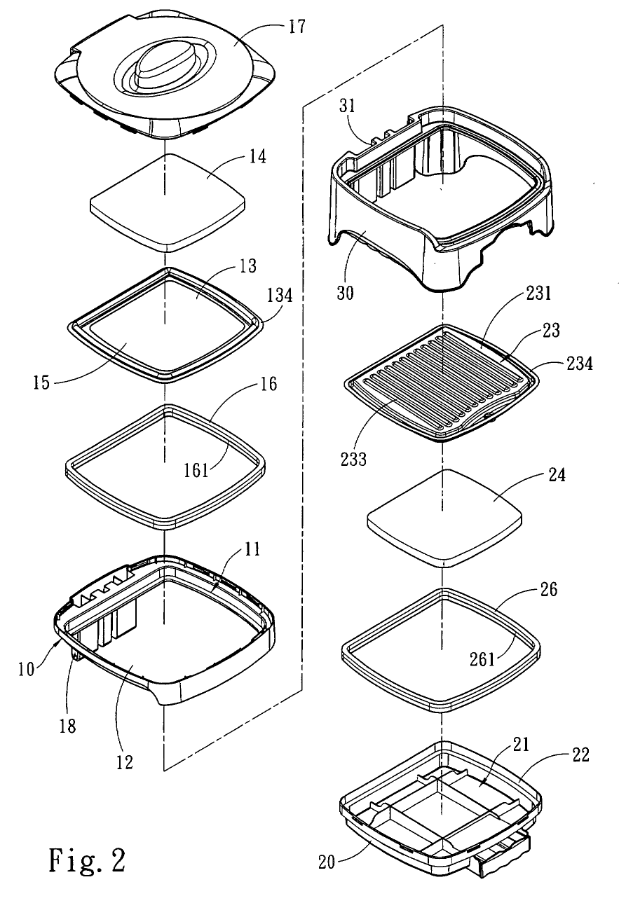

Please refer to FIGS. 1 and 2 for an embodiment of the invention. The heat isolation structure for baking trays of the invention includes a main body 30 which has a first base 10 and a second base 20 located respectively at an upper side and a lower side relative to each other that are pivotally coupled together through coupling units 31 and 18 so that they can rotate relative to each other within a selected range. Take the second base 20 as an example, it has a second housing space 21 and a second open surface 22 located therein. The second open surface has a second heat transfer element 23 to transfer heat energy. The second heat transfer element 23 has the peripheral side interposed by an annular second spacer 26 with the second base 20 to isolate the heat energy. The second heat transfer element 23 and the second spacer 26 have respectively a second flange 234 at one side and a second positioning portion 261 mating each other so that the second heat transfer element 23 and the second base 20 can form a secured positioning relationship through the second spacer 26.

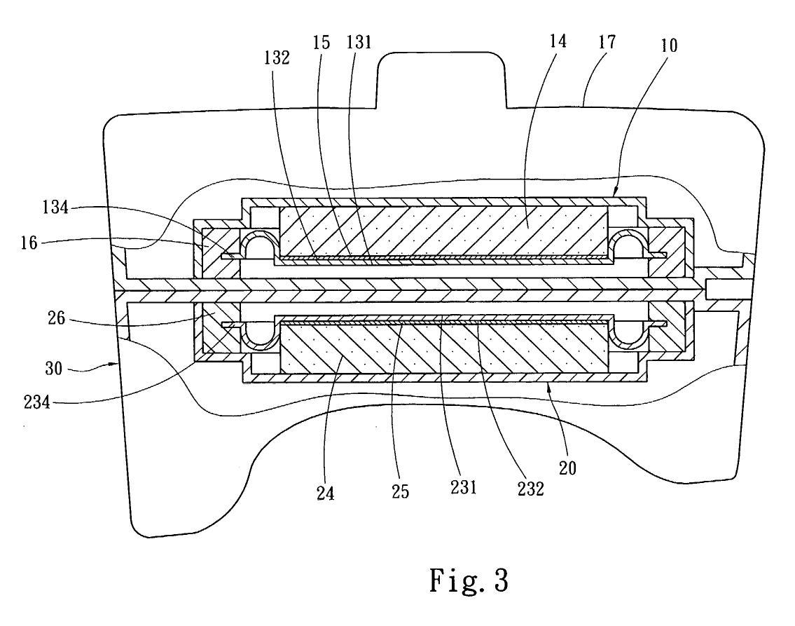

The second heat transfer element 23 has a first surface 231 in contact with food and a second surface 232 at another side opposing the first surface 231 (also referring to FIG. 3). The second surface 232 has a second microwave absorption portion 25 to absorb microwaves. The second microwave absorption portion 25 may be a microwave absorbing material coating on the second surface 232. The first surface 231 further has a plurality of ridges 233 to form baking traces on the food surface after the cooking is finished to form an appealing food presentation. The second housing space 21 further has a second heat isolation member 24 (may be a heat isolation cotton) interposed between the second base 20 and the second surface 232 to prevent the heat energy from transferring to the second base 20.

The first base 10 has an upper lid 17. Like the second base 20, the first base 10 has a first housing space 11 and a first open surface 12 located therein. The first open surface 12 has a first heat transfer element 13 to transfer the heat energy. The first heat transfer element 13 has the peripheral side interposed by an annular first spacer 16 with the first base 10 to isolate the heat energy. The first heat transfer element 13 and the first spacer 16 have respectively a first flange 134 at one side and a first positioning portion 161 at one side thereof corresponding to the first spacer 16 mating each other so that the first heat transfer element 13 and the first base 10 can form a secured positioning relationship through the first spacer 16. The first heat transfer element 13 has a first surface 131 in contact with the food (also referring to FIG. 3), and a second surface 132 at another side opposing the first surface 131. The second surface 132 has a first microwave absorption portion 15 to absorb microwave (may be a microwave absorbing coating). The first housing space 11 further has a first heat isolation member 14 (may be a heat isolation cotton) interposed between the first base 10 and the second surface 132 to prevent the heat energy of the first heat transfer element 13 from transferring to the first base 10.

By means of the heat isolation members 14 and 24, the high temperature heat energy of the heat transfer elements 13 and 23 can be prevented from transferring to the first base 10 and second base 20. For the baking trays made from plastics that tend to be damaged by burning or melting due to overheating from the heat transfer elements 13 and 23, the heat isolation members 14 and 24 of the invention can overcome the problem mentioned above. The annular spacers 16 and 26 located on the peripheral side of the heat transfer elements 13 and 23 also can provide heat isolation effect. In addition, they also provide secured positioning of the heat transfer elements 13 and 23 on the first and second bases 10 and 20.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A heat isolation structure for baking trays, comprising:
a base which has a housing space and an open surface formed in the housing space;
a heat transfer element located on the open surface that has a first surface in contact with food and a second surface located on another side opposing the first surface; and
a heat isolation member located in the housing space between the base and the second surface to isolate heat energy from transferring to the base.

2. The heat isolation structure for baking trays of claim 1, wherein each of the trays has two opposing bases located in a up and down manner, the two bases being pivotally coupled through a coupling unit such that they are allowed to rotate relative to each other within a selected range.

3. The heat isolation structure for baking trays of claim 1, wherein the first surface of the heat transfer element has a plurality of ridges to generate baking traces.

4. The heat isolation structure for baking trays of claim 1, wherein the second surface of the heat transfer element has a microwave absorption portion to absorb microwaves.

5. The heat isolation structure for baking trays of claim 1, wherein the heat transfer element has the peripheral side interposed by an annular spacer with the base to isolate the heat energy, the heat transfer element being positioned on the base through the spacer.

6. The heat isolation structure for baking trays of claim 5, wherein the heat transfer element and the spacer have respectively a flange and a positioning portion mating each other.

7. The heat isolation structure for baking trays of claim 1, wherein the heat isolation member is isolation cotton.
